(19) United States
(12) Patent Application Publication
(10) Pub. No.: US 2008/0016962 A1
(43) Pub. Date: Jan. 24, 2008

(54) MEDICAL USE ANGULAR RATE SENSOR

(75) Inventors: Michael D. Dwyer, Seminole, FL (US); William C. Bourne, Seminole, FL (US); John W. Thornberry, Largo, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc,, Morristown, NJ (US)

(21) Appl. No.: 11/459,553

(22) Filed: Jul. 24, 2006

(51) Int. Cl. G01P 15/14; G01P 9/00

(52) U.S. Cl. 73/504.02; 73/504.03

(57) ABSTRACT

A sensor unit to detect a falling event that includes a gyroscope attached to a monitored person, a micro-controller communicatively coupled to the gyroscope, and a memory communicatively coupled to receive and to store angular velocity data with a correlated time. The gyroscope senses an angular velocity of the monitored person and outputs the angular velocity data based on the sensed angular velocity. The micro-controller receives the angular velocity data and recognizes falling-pattern data in the angular velocity data.

### CROSS-REFERENCE TO RELATED APPLICATIONS

This application is related to U.S. patent applications Ser. No. ______ (Attorney Docket No. H0012351.73694) having a title of “MEDICAL APPLICATION FOR NO-MOTION SENSOR” (also referred to here as the “H0012351.73694 Application”), which is filed on the same date herewith. The H0012351.73694 application is hereby incorporated herein by reference.

### BACKGROUND

Elderly people living alone are susceptible to accidents which can leave them in positions from which they cannot summon help. For example, if an elderly woman falls and breaks her hip when she is out of reach of a telephone, she can lie unassisted for several hours or even longer. If a fallen person is unassisted for too long, complications can arise, such as dehydration and exposure to cold, which degrade the health of the fallen person and which make recovery from any injuries more difficult. When medical assistance arrives, it is helpful if the medical personnel know exactly what happened. If the monitored person is disoriented or unconscious, they will not be able to provide a clear description of their fall.

There are sensor systems to detect a fall but such sensors only transmit a signal to indicate a fall has occurred. There is no supporting data related to the magnitude of the impact from the fall. In some cases, the sensors transmit an incorrect signal and falsely indicate the occurrence of a fall.

Some sensors are bulky and uncomfortable for the monitored person wearing the sensor. In some cases, the monitored person does not use an available sensor system because of the discomfort.

It is desirable to have a compact, lightweight low cost, accurate sensor system to provide data that helps the attending physician understand the falling event.

### SUMMARY

One aspect of the present invention includes a sensor unit to detect a falling event. The sensor unit includes a gyroscope attached to a monitored person, a micro-controller communicatively coupled to the gyroscope, and a memory communicatively coupled to receive and to store angular velocity data with a correlated time. The gyroscope senses an angular velocity of the monitored person and outputs the angular velocity data based on the sensed angular velocity. The micro-controller receives the angular velocity data and recognizes falling-pattern data in the angular velocity data.

### DRAWINGS

FIG. 1 is a block diagram of one embodiment of a sensor unit to detect a falling event in accordance with the present invention.

FIG. 2 is a block diagram of one embodiment of a sensor unit to detect a falling event in communication with an external monitor system in accordance with the present invention.

FIG. 3 is a flow diagram of one embodiment of a method to sense a falling event in accordance with the present invention.

FIGS. 4A-4C show diagrams of a monitored person at three moments during one embodiment of a falling event in which a sensor unit is implemented in accordance with the present invention.

FIGS. 5A-5D are plots of exemplary angular velocity and linear acceleration sensed while a monitored person is walking.

FIG. 6A-6D are plots of exemplary angular velocity and linear acceleration sensed while a monitored person is walking and then falling.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

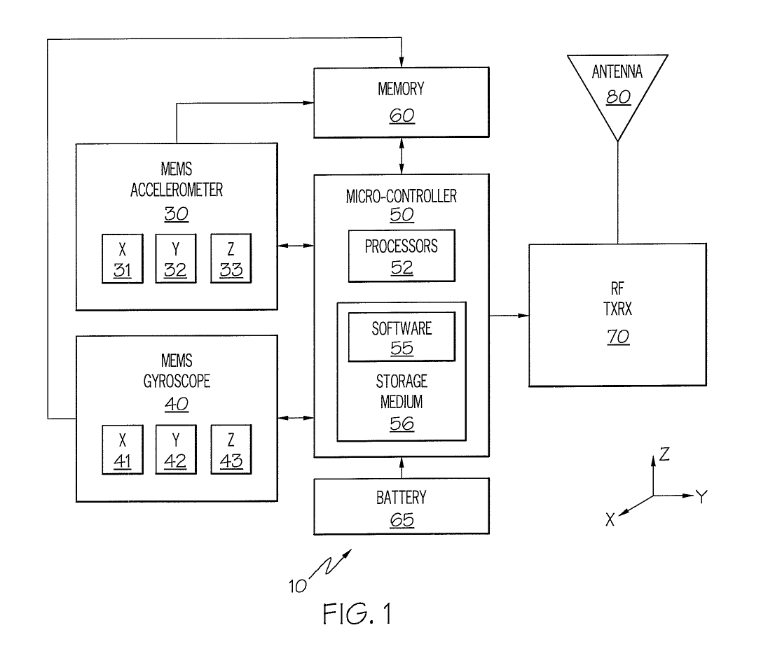

FIG. 1 is a block diagram of one embodiment of a sensor unit 10 to detect a falling event in accordance with the present invention. The sensor unit 10 includes a gyroscope 40, an accelerometer 30, a micro-controller 50, a memory 60, a battery 65, a transceiver 70 and an antenna 80. The gyroscope 40 is referred to here as a “micro-electro-mechanical system (MEMS) gyroscope 40” although other gyroscopes can be used in the sensor unit 10. Likewise, the accelerometer 30 is referred to here as a “micro-electro-mechanical system (MEMS) accelerometer 30” although other accelerometers can be used in the sensor unit 10. The gyroscope 40 and the accelerometer 30 measure the angular velocity and the linear acceleration, respectively, in at least two dimensions. The MEMS gyroscope 40 and the MEMS accelerometer 30 are small, lightweight and low cost so the sensor unit 10 is also small, lightweight and low cost. The micro-controller 50 recognizes falling pattern data in the acceleration/velocity data received from the accelerometer 30 and the gyroscope 40. As defined herein, the acceleration/velocity data includes the linear acceleration sensed by the accelerometer 30 and the angular velocity sensed by the gyroscope 40. In one implementation of this embodiment, the micro-controller 50 generates an angular acceleration by differentiating the angular velocity sensed by the gyroscope 40. In this case, the acceleration/velocity data includes the linear acceleration sensed by the accelerometer 30 and the angular acceleration calculated from the angular velocity. In another implementation of this embodiment, the acceleration/velocity data includes the linear acceleration sensed by the accelerometer 30, the angular velocity sensed by the gyroscope 40, and the angular acceleration calculated from the angular velocity sensed by the gyroscope 40.

The sensor unit 10, including the gyroscope 40, is attached to a monitored person in order to monitor the angular velocity of the monitored person. The gyroscope 40 senses an angular velocity of the monitored person and outputs angular velocity data based on the sensed angular velocity.

As shown in FIG. 1, the MEMS gyroscope 40 includes an X-direction gyroscope sensor 41 aligned for a selected X axis, a Y-direction gyroscope sensor 42 aligned for a selected Y axis, a Z-direction gyroscope sensor 43 aligned for a selected Z axis. The X-direction gyroscope sensor 41, the Y-direction gyroscope sensor 42, and the Z-direction gyroscope sensor 43 measure angular velocity about the X axis, the Y axis and the Z axis, respectively. The relative changes in the sensed acceleration/velocity data are monitored for a falling event. The X axis, the Y axis and the Z axis are orthogonal to each other as shown by the basis vectors X, Y, and Z in FIG. 1. In one implementation of this embodiment, there is no Z-direction gyroscope sensor 43.

The accelerometer 30 is also attached to the monitored person. In one implementation of this embodiment, the accelerometer 30 is co-located with the gyroscope 40. The accelerometer 30 senses a linear acceleration of the monitored person and outputs linear acceleration data based on the sensed linear acceleration.

As shown in FIG. 1, the MEMS accelerometer 30 includes an X-direction accelerometer sensor 31 aligned along the selected X axis, a Y-direction accelerometer sensor 32 aligned along the selected Y axis, a Z-direction accelerometer sensor 33 aligned along the selected Z axis. The X-direction accelerometer sensor 31, the Y-direction accelerometer sensor 32, and the Z-direction accelerometer sensor 33 measure linear acceleration along the X axis, the Y axis and the Z axis, respectively. In one implementation of this embodiment, the accelerometer 30 monitors relative changes in the sensed acceleration/velocity data for a falling event.

The micro-controller 50 is communicatively coupled to the gyroscope 40 to receive the angular velocity data from the gyroscope 40. The micro-controller 50 is also communicatively coupled to the accelerometer 30 to receive the linear acceleration data from the accelerometer 30. The micro-controller 50 recognizes the falling-pattern data in the sensed angular velocity data and linear acceleration data. In one implementation of this embodiment, the micro-controller 50 wirelessly communicates with the gyroscope 40 and the accelerometer 30 via transceivers in the micro-controller 50, the gyroscope 40 and the accelerometer 30. The wireless communication link (for example, a radio-frequency (RF) communication link) can be a short range communication provided according to Bluetooth or WiFi standards. In another implementation of this embodiment, the micro-controller 50 communicates with the gyroscope 40 and the accelerometer 30 via wired communication link (for example, an optical fiber or copper wire communication link).

In one implementation of this embodiment, the sensor unit 10 includes an accelerometer 30 and does not include a gyroscope 40. In this case, the micro-controller 50 recognizes the falling-pattern data in the sensed linear acceleration data. In another implementation of this embodiment, the sensor unit 10 includes a gyroscope 40 and does not include the accelerometer 30. In one implementation of this latter embodiment, the micro-controller 50 recognizes the falling-pattern data in the sensed angular velocity data. In another implementation of this latter embodiment, the micro-controller 50 generates angular acceleration data from the angular velocity data and recognizes the falling-pattern data in the angular acceleration data.

The memory 60 is communicatively coupled to the gyroscope 40 to receive the angular velocity data and to store the angular velocity data with a correlated time. In one implementation of this embodiment, the correlated time is the time at which the angular velocity data was output to the memory 60. In this case, the angular velocity data is time stamped on output to the memory 60. In another implementation of this embodiment, the memory 60 is communicatively coupled to the gyroscope 40 via the micro-controller 50. In this case, the micro-controller 50 generates the correlated time and outputs the sensed angular data and the correlated time to the memory 60. In another implementation of this embodiment, the correlated time is the time at which the angular velocity data was received at the micro-controller 50 minus a known latency for the data to be sent from the gyroscope 40 to the micro-controller 50. In this case, the known latency is deleted from the time of receipt of the angular velocity data at the micro-controller 50.

In an implementation in which the micro-controller 50 generates angular acceleration data from the angular velocity data, the angular acceleration data is stored in the memory 60 with a time stamp.

The memory 60 is also communicatively coupled to the accelerometer 30 to receive the linear acceleration data and to store the linear acceleration data with the correlated time. In one implementation of this embodiment, the correlated time is the time at which the linear acceleration data was output to the memory 60. In another implementation of this embodiment, the memory 60 is communicatively coupled to the accelerometer 30 via the micro-controller 50. The correlated time for the linear acceleration data is generated as described above for the angular velocity data.

In one implementation of this embodiment, the micro-controller 50 is clocked with a crystal oscillator and is programmable with the current date and time. In this manner, the elapsed time is measured and each sensed acceleration/velocity data received at the micro-controller 50 is time stamped with the date and time of the receipt of the message.

The communication link between the memory 60 and the gyroscope 40 and/or the accelerometer 30 comprises one or more of a wireless communication link (for example, a radio-frequency (RF) communication link) and/or a wired communication link (for example, an optical fiber or copper wire communication link). The communication link between the micro-controller 50 and the gyroscope 40 and/or the accelerometer 30 comprises one or more of a wireless communication link (for example, a radio-frequency (RF) communication link) and/or a wired communication link (for example, an optical fiber or copper wire communication link). The communication link between the memory 60 and the micro-controller 50 comprises one or more of a wireless communication link (for example, a radio-frequency (RF) communication link) and/or a wired communication link (for example, an optical fiber or copper wire communication link).

In one implementation of this embodiment, the memory 60 stores both angular velocity for three directions and linear acceleration for three directions for the same correlated time. In one implementation of this embodiment, the linear acceleration, the angular velocity and the correlated time are stored in a table that sorts the table to store the accelerations in the sequence in which they were sensed.

The micro-controller 50 includes one or more processors 52 that execute software 55 that is stored in a storage medium 56. The software 55 is executed by the processor 52 to determine if sensed angular velocity data and/or linear angular velocity data matches falling-pattern data. The software 55 executed by processor 52 is implemented to determine if the angular velocity data follows the falling-pattern data for at least two consecutive times.

A falling-event signal is generated by the micro-controller 50 when the angular velocity data follows the falling-pattern data. Likewise, a falling-event signal is generated by the micro-controller 50 if the linear acceleration data follow the falling-pattern data. In another implementation of this embodiment, the falling-event signal is generated by the micro-controller 50 if the linear acceleration data and the angular velocity data follow the falling-pattern data.

The falling event signal is wirelessly transmitted from a radio frequency transmitter 70 via the antenna 80. The radio frequency transceiver 70 is communicatively coupled to the micro-controller 50 and the antenna 80. The micro-controller 50 communicates with the radio frequency transceiver 70 via a wireless communication link (for example, a radio-frequency (RF) communication link) or a wired communication link (for example, an optical fiber or copper wire communication link).

The kinematics for modeling a fall of the human body as known in the art are used to generate the software 55 based on the position of each accelerometer 30 and the sensed linear acceleration for each accelerometer 30, as well as the position of each gyroscope 40 and the linear acceleration of each gyroscope 40. In one implementation of this embodiment, there are gyroscopes 40 and accelerometers 30 attached to different locations on the monitored person. In another implementation of this embodiment, the software 55 is generated based on modeling that uses for the height and weight of the monitored person using the sensor unit 10. In another implementation of this embodiment, the software 55 is generated based on modeling that uses for the height and weight and disability of the monitored person using the sensor unit 10. For example, if the monitored person is usually in a wheel chair, the software 55 is also generated with information indicative of the center of gravity of the monitored person while sitting in the wheel chair.

In an exemplary implementation, gyroscopes 40 and accelerometers 30 are co-located on a shoulder, a hip and each wrist of the monitored person. In this case, the detected angular rotation at the wrists, due to swinging of the arms of the monitored person while they walk, is sensed by the gyroscope 40 and the micro-controller 50 recognizes that this sensed arm-swinging angular velocity is not falling-pattern data. In an exemplary falling event, if a linear acceleration data greater than a high-gravity threshold is detected at the accelerometers 30 on the wrists of the monitored person at a first time to, and a linear acceleration data greater than a high-gravity threshold is detected at the accelerometer 30 located on the hip of the monitored person at a second time t₁, where t₁=t₀+Δt and where Δt is small, then the micro-controller 50 recognizes a falling event in which the monitored person's hands hit the ground before their hips so they put their arms out to break the fall. Given this information, the attending physician knows to look for damage to the wrist of the monitored person. In one implementation of this embodiment, Δt is 1/30 second.

The sensor unit 10 is powered by a battery 65. The battery can be a fuel cell, a primary or non-rechargeable battery, a secondary or rechargeable battery, or a thin-film battery.

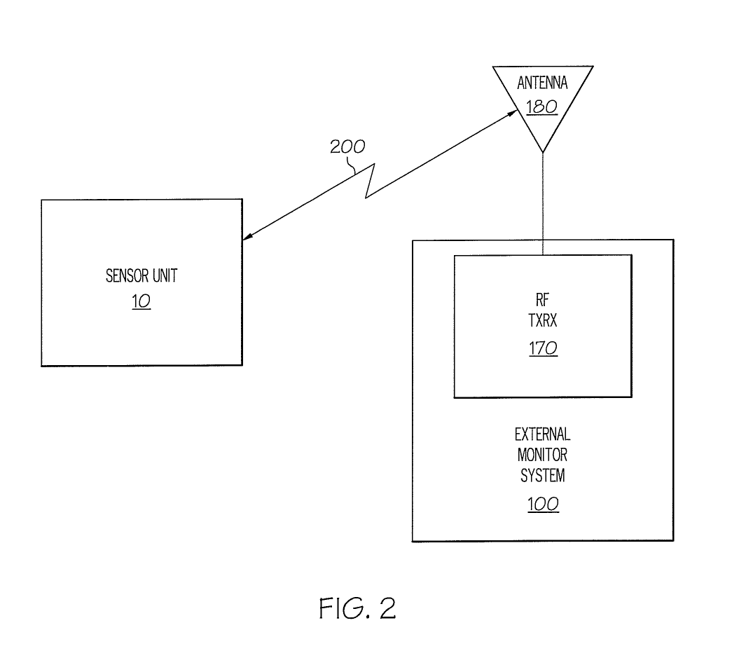

FIG. 2 is a block diagram of one embodiment of a sensor unit 10 to detect a falling event in communication with an external monitor system 100 in accordance with the present invention. The antenna 80 receives wireless signals from the sensor unit 10 via wireless communication link 200. In another implementation of this embodiment, the communication link 200 that is partially wireless and partially wired. In yet another implementation of this embodiment, an antenna is communicatively coupled to a wireless device (for example, a wireless laptop) in the home of the monitored person and the home-based device connects to the external monitor system 100 via communication links (either wireless or wired) to send the falling-event signal to the external monitor system 100. In one implementation of this embodiment, the device is a personal computer and the falling-event signal received at the personal computer is transmitted via the Internet to the external monitor system 100.

In yet another implementation of this embodiment, the software to analyze the angular velocity data and the memory are located in the external monitor system 100. In this implementation, the angular velocity data is analyzed by one or more processors at the external monitor system 100 and the falling-event signal is generated at the external monitor system 100.

As shown in FIG. 2, the external monitor system 100 includes an antenna 180 that detects the transmitted falling event signal, which is then received at the radio frequency transceiver 170 in the external monitor system 100.

The falling-pattern data includes: angular velocity data greater than a falling threshold; angular acceleration data greater than a falling threshold; linear acceleration data greater than a high-gravity threshold; angular velocity data greater than the falling threshold followed by linear acceleration data greater than the high-gravity threshold; angular acceleration data greater than the falling threshold followed by linear acceleration data greater than the high-gravity threshold; angular velocity data indicative of a roll; angular acceleration data indicative of a roll; side-to-side angular velocity data followed by angular velocity data greater than the falling threshold, the side-to-side angular velocity data followed by the angular velocity data greater than the falling threshold followed by the linear acceleration data greater than the high-gravity threshold; the side-to-side angular velocity data followed by the linear acceleration data greater than the high-gravity threshold; the side-to-side angular velocity data followed by the angular velocity data greater than the falling threshold followed by the linear acceleration data greater than the high-gravity threshold followed by the angular velocity data indicative of the roll; the linear acceleration data greater than the high-gravity threshold followed by the angular velocity data indicative of the roll; side-to-side angular acceleration data followed by angular acceleration data greater than the falling threshold, the side-to-side angular acceleration data followed by the angular acceleration data greater than the falling threshold followed by the linear acceleration data greater than the high-gravity threshold; the side-to-side angular acceleration data followed by the linear acceleration data greater than the high-gravity threshold; the side-to-side angular acceleration data followed by the angular acceleration data greater than the falling threshold followed by the linear acceleration data greater than the high-gravity threshold followed by the angular acceleration data indicative of the roll; and the linear acceleration data greater than the high-gravity threshold followed by the angular acceleration data indicative of the roll. Other falling-patterns are possible.

A falling threshold for angular velocity is stored in memory 60 and is a value having units of radians per second or degrees per second. A falling threshold for angular acceleration is stored in memory 60 and is a value in radians per second squared or degrees per second squared. A falling threshold for linear acceleration is stored in memory 60 and is a value having units of meters per second squared. When the sensed angular velocity data, angular acceleration, and/or linear acceleration has a value greater than the respective falling threshold, the monitored person in moving at rate that makes it difficult, if not impossible, for the monitored person to avoid falling. A high-gravity threshold is a value in meters per second squared (m/s²) and is stored in memory 60. When the sensed linear acceleration data has a value greater than the high-gravity threshold the monitored person has come to an abrupt stop, which indicates that the monitored person has hit an object or surface with potentially damaging force. An angular velocity data (and/or associated angular acceleration data) indicative of a roll includes a sequentially sensed continuing angular velocity ((and/or associated angular acceleration) in one direction or in a superposition of two directions or in a superposition of three directions. In one implementation of this embodiment, the rate of the angular velocity and the duration of the continuing angular velocity have thresholds or combined thresholds which are recognized by the micro-controller 50 as a falling-pattern.

An exemplary side-to-side angular velocity occurs when the acceleration is sequentially sensed first in the +X-direction, second in the −X-direction and third in the +X-direction, all while the monitored person is moving in the Z-direction. The movement of the monitored person in the Z-direction is detected as a ±Z linear acceleration. In one implementation of this embodiment, the movement of the monitored person in the ±Z-direction is detected by a global positioning system (GPS) (not shown) that is also in the sensor unit 10.

In one implementation of this embodiment, the falling-event signal is transmitted to the external monitor system 100 and a message “Joe Smith has fallen at 2:36 PM Saturday, Jun. 10, 2006” is displayed on a monitor (not shown) at the external monitor system 100. In another implementation of this embodiment, the falling-event signal is transmitted to the external monitor system 100 and an audio message “Joe Smith located at 10 μm Street in Ocean View, Calif. has fallen at 2:36 PM Saturday, Jun. 10, 2006” is delivered a person on a telephone located at the external monitor system 100. In this latter implementation, the address may be generated by a global positioning system in the sensor unit 10. Alternatively in this latter implementation, the address may be generated by information in the memory 60 in the sensor unit 10 that the monitored person is housebound at 10 μm Street in Ocean View, Calif.

The removal of the Z-direction accelerometer sensor 33 does not affect those monitored persons who are not linearly accelerating in the vertical direction. In an exemplary implementation of this embodiment, the monitored person is a soldier who is being monitored while parachuting from an airplane and the gyroscope 40 and the accelerometer 30 monitor the soldier's impact on the ground. In this case, the Z-direction accelerometer sensor 33 is useful. The Z-direction gyroscope sensor 43 monitors rotations of the monitored person as they turn around while standing-up or as they roll over while lying in bed.

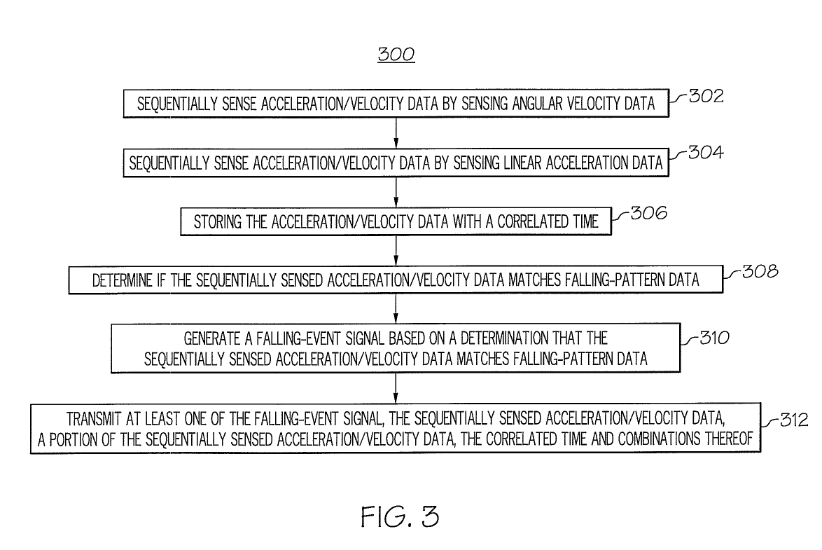

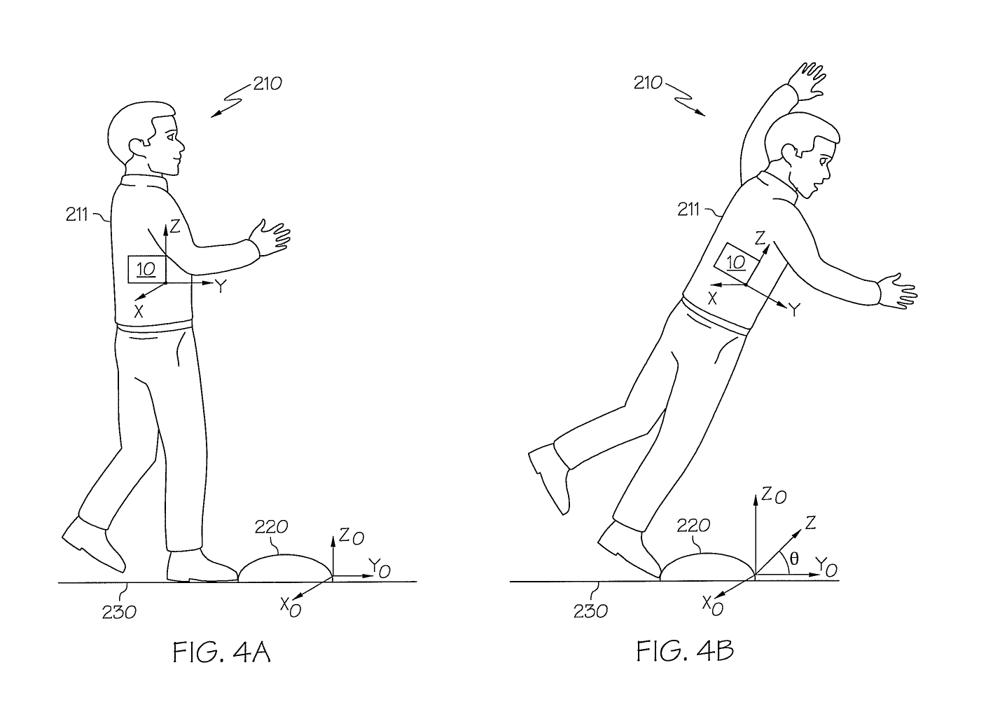

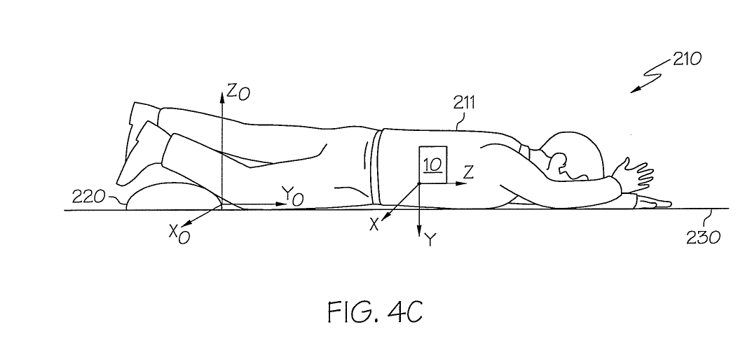

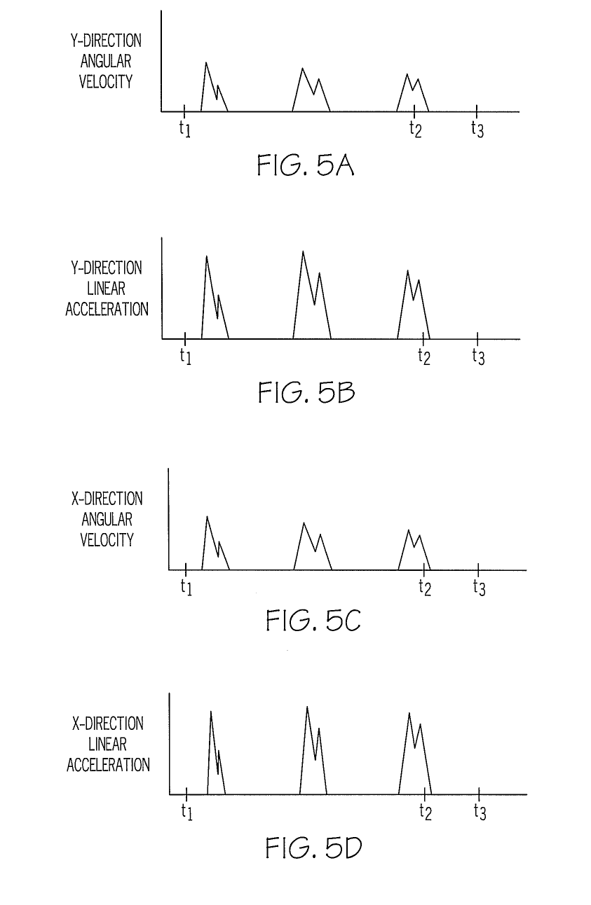

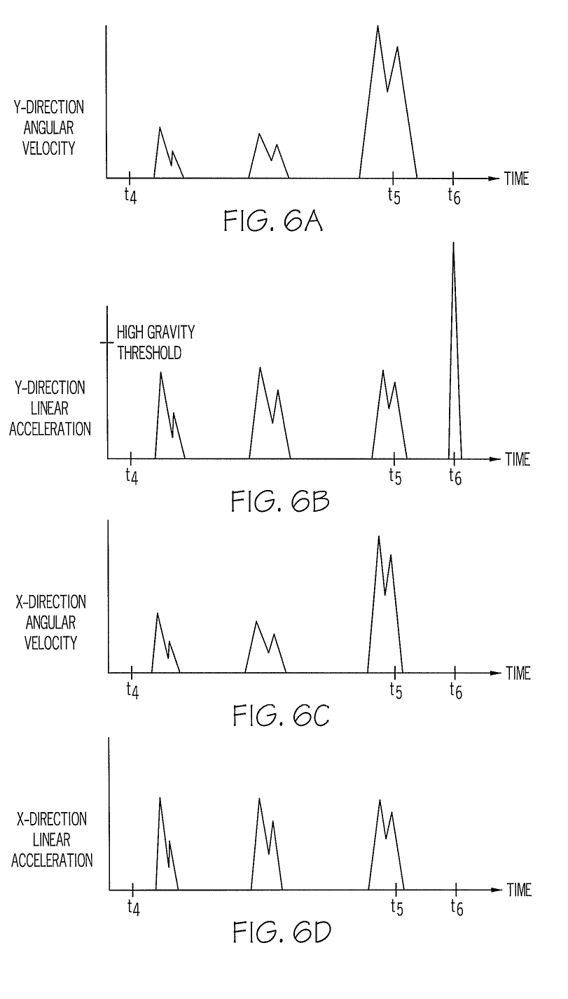

FIG. 3 is a flow diagram of one embodiment of a method 300 to sense a falling event in accordance with the present invention. Method 300 is described with reference to sensor unit 10 and with reference to an exemplary falling event as depicted in FIGS. 4A-4C. FIGS. 4A-4C show diagrams of a monitored person at three moments during one embodiment of a falling event in which a sensor unit 10 is implemented in accordance with the present invention. The person, represented generally by the numeral 210, is also referred to here as “monitored person 210.” Method 300 is also described with reference to FIGS. 5A-5D and FIGS. 6A-6D. FIGS. 5A-5D are plots of exemplary angular velocity and linear acceleration sensed while a monitored person is walking. FIG. 6A-6D are plots of exemplary angular velocity and linear acceleration sensed while a monitored person is walking and then falling. In these exemplary plots, background noise that is generated by the gyroscopes and the accelerometers is not shown in order to emphasize the signals. The sensed data is processed to remove or average out the background noise generated by the gyroscope and the accelerometers.

At block 302, the sensor unit sequentially senses acceleration/velocity data by sensing angular velocity data at a gyroscope attached to the monitored person. In one implementation of this embodiment, the MEMS gyroscope 40 in the sensor unit 10 that is attached to the monitored person 210 sequentially senses acceleration/velocity data by sensing angular velocity data. In another implementation of this embodiment, sequentially sensing angular velocity data includes calculating angular acceleration data by differentiating the angular velocity data. In this case, the acceleration/velocity data includes the angular acceleration data. In one embodiment of this implementation, the micro-controller 50 differentiates the angular velocity data to generate the angular acceleration data.

At block 304, the sensor unit sequentially senses acceleration/velocity data by sensing linear acceleration data at the accelerometer attached to the monitored person. In one implementation of this embodiment, the MEMS accelerometer 30 in the sensor unit 10 that is attached to the monitored person 210 sequentially senses acceleration/velocity data by sensing linear acceleration data.

As shown in sequential time frames in FIGS. 4A-4C, monitored person 210 trips on the object 220 located at a position at the origin of the Xₒ, Yₒ, and Zₒ axes. At the time, such as t₁, depicted in FIG. 4A, the monitored person 210 is walking on the surface represented generally by the numeral 230 in the Y-direction (with respect to the X, Y, and Z axes of the sensor unit 10) and their foot touches the object 220. Just prior to the exemplary falling event, the sensor unit 10 is located at a position at the origin of the X, Y, and Z axes and the Xₒ, Yₒ, and Zₒ axes are aligned parallel to the X, Y, and Z axes, respectively.

At a time t₁+Δt (where Δt is small) depicted in FIG. 4B, the torso 211 of the monitored person 210 is at an angle θ with the surface 230 (as shown between the Z axis of the sensor unit 10 and the Yₒ axis of the object 220). The position of the sensor unit 10 has rotated by (π/2−θ) within the time Δt so the sensor unit 10 experienced an angular velocity of [(π/2−θ)/(Δt)]. As the monitored person 210 falls during the time frame from time t₁ to time (t₁+2Δt), the sensor unit 10 moves forward at a constant velocity for is a linear acceleration of zero (0).

At a time (t₁+2Δt) depicted in FIG. 4C, the length of the torso 211 of the monitored person 210 is at a zero degree angle with the surface 230 and the Z axis of the sensor unit 10 is parallel to the Yₒ axis of the object 220. The position of the sensor unit 10 has rotated by 90° or π/2 radians within the duration of 2Δt. Between the times t₁ and (t₁+2Δt) the monitored person 210 experienced a falling event.

In order to describe a sensed falling event, it is useful to first describe a sensed walking event during which time the monitored person 210 does not fall. FIGS. 5A-5D are plots of exemplary angular velocity and linear acceleration sensed while a monitored person is walking. The data that is plotted in FIGS. 5A-5D is sensed simultaneously for the same time frame from time t₁ to time t₃. In one implementation of this embodiment, the data is sensed 30 times per second. There is no falling event detected in the duration of time t₁ to time t₃. The gyroscope 40 senses angular velocity and a plot of the angular velocity in the Y-direction and the X-direction for the plurality of moments between time t₁ and time t₃ is shown in FIGS. 5A and 5C, respectively. The accelerometer 30 senses linear acceleration and a plot of the linear acceleration in the Y-direction and the X-direction for a plurality of moments between time t₁ and time t₃ is shown in FIGS. 5B and 5D, respectively.

FIG. 5A is a plot of sensed angular velocity about the Y axis in time that is sensed as the monitored person 210 walks. FIG. 5B is a plot of sensed linear acceleration in the Y-direction versus time that is sensed as the monitored person 210 walks. FIG. 5C is a plot of sensed angular velocity about the X axis in time that is sensed as the monitored person 210 walks. FIG. 5D is a plot of sensed linear acceleration in the X-direction versus time that is sensed as the monitored person 210 walks. In these exemplary plots there are a plurality of peaks for each of the plots that are sensed by sensors on the monitored person 210 including a peak just prior to or at time t₂.

FIG. 6A-6D are plots of angular velocity and linear acceleration sensed for the monitored person walking and then falling from the time t₄ to time t₆. The time t₄ through time t₆ is the time during which the falling event shown in FIGS. 4A-4C occurs. The gyroscope 40 senses angular velocity and a plot of the angular velocity in the Y-direction and the X-direction for the plurality of moments between time t₄ and time t₆ is shown in FIGS. 6A and 6C, respectively. The accelerometer 30 senses linear acceleration and a plot of the linear acceleration in the Y-direction and the X-direction for a plurality of moments between time t₄ and time t₆ is shown in FIGS. 6B and 6D, respectively.

The monitored person 210 has fallen by time t₆ so there is a falling event detected in the duration of time t₃ to time t₆. FIG. 6A is a plot of sensed angular velocity about the Y axis in time that is sensed as the monitored person 210 walks and then falls. FIG. 6B is a plot of sensed linear acceleration in the Y-direction versus time that is sensed as the monitored person 210 walks and then falls. FIG. 6C is a plot of sensed angular velocity about the X axis in time that is sensed as the monitored person 210 walks and then falls. FIG. 6D is a plot of sensed linear acceleration in the X-direction versus time that is sensed as the monitored person 210 walks and then falls. The data that is plotted in FIGS. 6A-6D is sensed simultaneously for the same time frame from time t₄ to time t₆.

The time t₄ in FIGS. 6A-6D correlates to the time t₁ in FIGS. 5A-5D. The time t₅ in FIGS. 6A-6D correlates to the time t₂ in FIGS. 5A-5D. Likewise, the time t₆ in FIGS. 6A-6D correlates to the time t₃ in FIGS. 5A-5D.

The measured X-direction angular velocity in FIG. 5C at time t₂ is smaller than the measured X-direction angular velocity in FIG. 6C at correlated time t₅. The measured Y-direction angular velocity in FIG. 5A at time t₂ is smaller than the measured Y-direction angular velocity in FIG. 6A at correlated time t₅. The differences indicate the increased rate of rotation of the monitored person 210 that occurs when the monitored person is falling, as shown in FIG. 4B.

There is large Y-direction linear acceleration at time t₆ in FIG. 6B that is not seen at the correlated time t₃ in FIG. 5B. This large Y-direction linear acceleration exceeds a high-gravity threshold that is indicted on the vertical axis. This is indicative that the monitored person 210 fell after time t₄. Specifically, at time t₆, the linear acceleration spikes since the sensor unit 10 decelerates abruptly when the monitored person 210 hits the surface 230 as shown in FIG. 4C.

At block 306, the micro-controller stores the acceleration/velocity data with a correlated time. In one implementation of this embodiment, the micro-controller 50 stores the acceleration/velocity data with a correlated time, such as time t₅ or t₆, in the memory 60 of sensor unit 10. In another implementation of this embodiment, the micro-controller 50 stores the acceleration/velocity data with a correlated time in a table in the memory 60 of sensor unit 10. FIGS. 5A-5D and FIGS. 6A-6D are plots of a portion of the data stored in a table in the memory 60.

In one implementation of this embodiment, the micro-controller 50 transmits the acceleration/velocity data with a correlated time for storage in the external monitor system 100 via the transceiver 70, antenna 80 and communication link 200.

At block 308, the micro-controller determines if the sequentially sensed acceleration/velocity data matches falling-pattern data. In one implementation of this embodiment, the micro-controller 50 determines if the sequentially sensed acceleration/velocity data, including the angular velocity data and linear acceleration data sensed during blocks 302 and 304, respectively, matches falling-pattern data as defined above with reference to FIG. 2. FIGS. 6A-6D show plots of one embodiment of falling-pattern data. The large Y-direction linear acceleration at time t₆ in FIG. 6B is part of the falling-pattern. The relatively large X-direction angular velocity in FIG. 6C at time t₅ and the relatively large Y-direction angular velocity in FIG. 6A at time t₅ are also part of the falling-pattern.

At block 310, the micro-controller generates a falling-event signal based on a determination that the sequentially sensed acceleration/velocity data matches falling-pattern data. In one implementation of this embodiment, the micro-controller 50 generates the falling-event signal based on sequentially sensed acceleration/velocity data that matches the falling-pattern data plotted in FIGS. 6A-6D.

At block 312, the micro-controller transmits at least one of the falling-event signal, the sequentially sensed acceleration/velocity data, a portion of the sequentially sensed acceleration/velocity data, the correlated time, and combinations thereof. In one implementation of this embodiment, micro-controller 50 transmits the falling-event signal to the external monitor system 100 when the micro-controller 50 determines the sequentially sensed acceleration/velocity data matches the falling-pattern data plotted in FIGS. 6A-6D. In another implementation of this embodiment, the micro-controller 50 transmits the sequentially sensed acceleration/velocity data and the correlated times to the external monitor system 100 and processors (not shown) in the external monitor system 100 determine that the sequentially sensed acceleration/velocity data matches a falling-pattern data and generate a falling-event signal. In yet another implementation of this embodiment, the accelerometer 30 and the gyroscope 40 send the sensed acceleration/velocity data to the micro-controller 50 and the micro-controller 50 sends the unprocessed sensed acceleration/velocity data to the external monitor system 100 via communication link 200. In this case, processors in the external monitor system 100 store the acceleration/velocity data with a correlated time, determine if the sequentially sensed acceleration/velocity data matches a falling-pattern data and generates a falling-event signal.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A sensor unit to detect a falling event, the sensor unit comprising:
a gyroscope attached to a monitored person, the gyroscope adapted to sense an angular velocity of the monitored person and to output angular velocity data based on the sensed angular velocity;
a micro-controller communicatively coupled to the gyroscope, the micro-controller adapted to receive the angular velocity data and to recognize falling-pattern data in the angular velocity data; and
a memory communicatively coupled to receive and to store the angular velocity data with a correlated time.

2. The sensor unit of claim 1, wherein a falling-event signal is generated if the angular velocity data follows the falling-pattern data.

3. The sensor unit of claim 1, the sensor unit further comprising:
an accelerometer attached to the monitored person, the accelerometer adapted to sense a linear acceleration of the monitored person and to output linear acceleration data based on the sensed linear acceleration, wherein the micro-controller is communicatively coupled to the accelerometer to receive the linear acceleration data and to recognize the falling-pattern data in the sensed angular velocity data and linear acceleration data, and wherein the memory is communicatively coupled to the accelerometer to receive and to store the linear acceleration data with a correlated time.

4. The sensor unit of claim 3, wherein a falling-event signal is generated if the micro-controller recognizes the falling-pattern data.

5. The sensor unit of claim 4, wherein the falling-pattern data includes at least one of angular velocity data greater than a falling threshold, angular acceleration data greater than a falling threshold, linear acceleration data greater than a high-gravity threshold, angular velocity data greater than the falling threshold followed by linear acceleration data greater than the high-gravity threshold, angular acceleration data greater than the falling threshold followed by linear acceleration data greater than the high-gravity threshold, angular velocity data indicative of a roll, angular acceleration data indicative of a roll, side-to-side angular velocity data followed by angular velocity data greater than the falling threshold, the side-to-side angular velocity data followed by the angular velocity data greater than the falling threshold followed by the linear acceleration data greater than the high-gravity threshold, the side-to-side angular velocity data followed by the linear acceleration data greater than the high-gravity threshold, the side-to-side angular velocity data followed by the angular velocity data greater than the falling threshold followed by the linear acceleration data greater than the high-gravity threshold followed by the angular velocity data indicative of the roll, the linear acceleration data greater than the high-gravity threshold followed by the angular velocity data indicative of the roll, side-to-side angular acceleration data followed by angular acceleration data greater than the falling threshold, the side-to-side angular acceleration data followed by the angular acceleration data greater than the falling threshold followed by the linear acceleration data greater than the high-gravity threshold, the side-to-side angular acceleration data followed by the linear acceleration data greater than the high-gravity threshold, the side-to-side angular acceleration data followed by the angular acceleration data greater than the falling threshold followed by the linear acceleration data greater than the high-gravity threshold followed by the angular acceleration data indicative of the roll, and the linear acceleration data greater than the high-gravity threshold followed by the angular acceleration data indicative of the roll.

6. The sensor unit of claim 4, the sensor unit further comprising:
a radio frequency transmitter;
an antenna communicatively coupled to the radio frequency transmitter, wherein the antenna further communicatively coupled to an external monitor system; and
a battery adapted to provide power to the sensor unit.

7. The sensor unit of claim 3, the sensor unit wherein the accelerometer and the gyroscope are micro-electro-mechanical systems adapted to measure the linear angular velocity and the angular velocity in at least two dimensions.

8. The sensor unit of claim 1, the micro-controller adapted to generate a falling-event signal upon recognition of the falling-pattern data.

9. The sensor unit of claim 8, the sensor unit further comprising:
a radio frequency transmitter; and
an antenna communicatively coupled to the radio frequency transmitter, the antenna further communicatively coupled to an external monitor system; and
a battery adapted to provide power to the sensor unit.

10. A method to sense a falling event, the method comprising:
sequentially sensing acceleration/velocity data;
storing the acceleration/velocity data with a correlated time; and
determining if the sequentially sensed acceleration/velocity data matches falling-pattern data.

11. The method of claim 10, the method further comprising:
generating a falling-event signal based on a determination that the sequentially sensed acceleration/velocity data matches falling-pattern data.

12. The method of claim 11 the method further comprising:
transmitting at least one of the falling-event signal, the sequentially sensed acceleration/velocity data, a portion of the sequentially sensed acceleration/velocity data, the correlated time and combinations thereof.

13. The method of claim 10, wherein sequentially sensing acceleration/velocity data comprises:
sensing angular velocity data.

14. The method of claim 13, wherein sequentially sensing acceleration/velocity data further comprises:
sensing linear acceleration data.

15. The method of claim 10, wherein sequentially sensing acceleration/velocity data comprises:
sensing linear acceleration data.

16. A program product comprising program instructions, embodied on a storage medium, that are operable to cause a programmable processor to:
sequentially sense acceleration/velocity data;
store the acceleration/velocity data with a correlated time; and
determine if the sequentially sensed acceleration/velocity data matches falling-pattern data.

17. The program product of claim 16, further comprising instructions operable to cause the programmable processor to:
generate a falling-event signal based on a determination that the sequentially sensed acceleration/velocity data matching the falling-pattern data.

18. The program product of claim 17, further comprising instructions operable to cause the programmable processor to:
transmit the falling-event signal based on a generation of the falling-event signal.

19. The program product of claim 16, wherein instructions operable to cause the programmable processor to sequentially sense acceleration/velocity data comprises instructions operable to cause the programmable processor to:
sense angular velocity data.

20. The program product of claim 19, wherein instructions operable to cause the programmable processor to sequentially sense acceleration/velocity data comprises instructions operable to cause the programmable processor to:
sense linear acceleration data.
